(19) United States
(12) Patent Application Publication
(10) Pub. No.: US 2019/0354923 A1
(43) Pub. Date: Nov. 21, 2019

(54) SHELF MANAGEMENT SYSTEM AND PROGRAM

(71) Applicant: TOSHIBA TEC KABUSHIKI KAISHA, Tokyo (JP)

(72) Inventors: Kazuki Taira, Ota Tokyo (JP); Masaaki Yasunaga, Sunto Shizuoka (JP); Norimasa Ariga, Izunokuni Shizuoka (JP); Keita Yamazaki, Mishima Shizuoka (JP)

(21) Appl. No.: 16/414,828

(22) Filed: May 17, 2019

(30) Foreign Application Priority Data
May 18, 2018 (JP) 2018-096207

(51) Int. Cl. G06Q 10/08; G06T 7/11; G06K 9/00; G06K 9/18; B60R 11/04

(52) U.S. Cl. CPC G06Q 10/087; G06T 7/11; G06T 2207/30252; G06K 9/18; B60R 11/04; G06K 9/00791

(57) ABSTRACT

According to an embodiment, a shelf management system includes an interface, a memory, and a processor. The interface receives an input of photographed image information including a plurality of photographed images photographed by changing a photographing position with respect to a shelf in which objects including commodities are disposed and photographing position information indicating photographing positions of the photographed images. The memory retains one photographed image among the plurality of photographed images as a reference image. The processor executes matching processing of the reference image and the other photographed images based on the photographing positions and image feature values and outputs information concerning the objects present in the shelf determined according to a result of the matching processing.

### CROSS-REFERENCE TO RELATED APPLICATION

This application is based upon and claims the benefit of priority from Japanese Patent Application No. 2018-096207, filed in May 18, 2018, the entire contents of which are incorporated herein by reference.

### FIELD

Embodiments described herein relate generally to a shelf management system and a shelf management program.

### BACKGROUND

There has been proposed a shelf management system that photographs a commodity shelf (a commodity display stand) disposed in a store or the like and acquires information concerning commodities, shelf labels, and the like present in the commodity shelf from a photographed image. In an actual store, because of restrictions such as disposition of a plurality of commodity shelves and narrow passages, it is often difficult to photograph, in one time of photographing, the entire range of the commodity shelf at resolution sufficient for image processing. Therefore, in actual operation, information concerning commodities disposed in commodity shelves in the store needs to be acquired from a plurality of photographed images obtained during a plurality of times of photographing.

As related art, there is a technique for obtaining, with respect to a plurality of photographed images obtained by a plurality of times of photographing, a single image according to characteristics and correlations in the photographed images. However, a large number of the same or closely resembling commodities are often displayed in a commodity shelf. Therefore, a highly accurate image processing result cannot be obtained by image processing in which only information included in the photographed images in the related art is used. The shelf management system is the system that acquires the information concerning the commodities and the shelf labels in the commodity shelf. Therefore, it is inefficient to apply complicated processing for the purpose of only generating a single image from a plurality of images.

### DESCRIPTION OF THE DRAWINGS

FIG. 1 is a block diagram illustrating a configuration example of a shelf data processing system functioning as a shelf management system according to a first embodiment;

FIG. 2 is a block diagram illustrating a configuration example of apparatuses configuring the shelf data processing system;

FIG. 3 is an exterior view illustrating the configuration of a moving photographing apparatus in the shelf management system;

FIG. 4 is an exterior view illustrating the configuration of the moving photographing apparatus;

FIG. 5 is a diagram for explaining a relation between a photographing range of a camera in the moving photographing apparatus and a commodity shelf;

FIG. 6 is a diagram for explaining a relation between the photographing range of the camera and a disposition state of commodities in the commodity shelf;

FIG. 7 is a schematic diagram for explaining an example in which the photographing range of the camera is simply calculated;

FIG. 8 is a plan view schematically illustrating a layout example of shelves in a store photographed by the camera;

FIG. 9 is a flowchart for explaining an operation example of the moving photographing apparatus;

FIG. 10 is a flowchart for explaining an operation example of image processing in an image processing apparatus of the shelf management system;

FIG. 11 is a flowchart for explaining an operation example of the image processing;

FIG. 12 is a flowchart for explaining an operation example of the image processing;

FIG. 13 is a diagram illustrating an example of data obtained in the image processing;

FIG. 14 is a diagram illustrating an example of data concerning objects in a photographed image obtained in the image processing;

FIG. 15 is a flowchart for explaining data processing concerning shelf allocation by a shelf analyzing apparatus of the shelf management system;

FIG. 16 is a flowchart for explaining an example of data processing concerning a shelf tag by the shelf analyzing apparatus;

FIG. 17 is a flowchart for explaining an example of processing for confirming an inventory state and the like of commodities in a commodity shelf by the shelf analyzing apparatus;

FIG. 18 is a block diagram illustrating a configuration example of a shelf management system according to a second embodiment;

FIG. 19 is a diagram illustrating an example of an exterior configuration of a portable terminal in the shelf management system;

FIG. 20 is a diagram for explaining a photographing example of a commodity shelf by the portable terminal; and

FIG. 21 is a flowchart for explaining an operation example of the portable terminal.

### DETAILED DESCRIPTION

An object of embodiments is to provide, in order to solve the problems described above, a shelf management system and a shelf management program that can highly accurately acquire data necessary for an analysis of a shelf in which commodities are disposed.

According to an embodiment, a shelf management system includes an interface, a memory, and a processor. The interface receives an input of photographed image information including a plurality of photographed images photographed by changing a photographing position with respect to a shelf in which objects including commodities are disposed and photographing position information indicating photographing positions of the photographed images. The memory retains one photographed image among the plurality of photographed images as a reference image. The processor executes matching processing of the reference image and the other photographed images based on the photographing positions and image feature values and outputs information concerning the objects present in the shelf determined according to a result of the matching processing.

First and second embodiments are explained below with reference to the drawings.

Shelf management systems according to the embodiments explained below are image processing systems that manage objects such as commodities and shelf labels in a commodity shelf (a commodity display stand) disposed in a store. The shelf management system photographs commodity shelves while moving and acquires information concerning objects such as commodities present in the commodity shelves from a photographed plurality of images. It is assumed that objects such as commodities and shelf labels (shelf tags) are disposed in a commodity shelf set in a store or the like. The commodities are disposed side by side on stages of the commodity shelf. The shelf labels are labels indicating price information and the like of the commodities disposed in the shelf. The shelf labels are disposed in positions corresponding to disposition positions of the commodities.

In the embodiments, it is assumed that the commodities displayed in the commodity shelves set in the store, the shelf labels, and the like are managed based on shelf allocation. The shelf allocation indicates which commodities are displayed where in which commodity shelf in the store. For example, information indicating the shelf allocation (shelf allocation information) is planned based on commodity shelf information and commodity information. The commodity shelf information is information concerning a commodity shelf and is information such as a type, a size, the number of stages, depth and height of the stages of the commodity shelf. The commodity information is information concerning commodities and is information such as types, package sizes, prices, and stock quantities of the commodities.

For example, a computer executes dedicated software for managing the shelf allocation to create the shelf allocation using the commodity shelf information and the commodity information. In the store, the commodities are displayed based on the created shelf allocation. Operation for, for example, collating the existing shelf allocation (shelf allocation plan) and an actual display state of the commodities is periodically performed.

The shelf allocation may be created based on a display state of the commodities in the commodity shelf set in the store. The shelf allocation may be created based on disposition states of the commodity shelves and the commodities in the store. In this case, information necessary for the shelf allocation creation is obtained by reading information (barcode information or the like for specifying the commodities) described on shelf labels set in positions corresponding to the commodities. Information (information indicating the disposition states of the commodity shelves and the commodities) necessary for the shelf allocation creation may be acquired from photographed images of the commodity shelves.

The shelf allocation is utilized not only to manage the disposition state of the commodities but also to confirm description content (e.g., written prices, best before dates, and shelf display periods) of the shelf labels. The shelf allocation is also utilized as data for managing position information of the commodities and the shelf labels in order to confirm a shelf inventory state of the commodities. The description content of the shelf labels and the inventory state of the commodities can be regarded as information indicating display state of the commodities and the shelf labels. Therefore, these kinds of information are also treated as shelf allocation related information in this embodiment.

### First Embodiment

The configuration of an image processing system functioning as a shelf management system according to a first embodiment is explained.

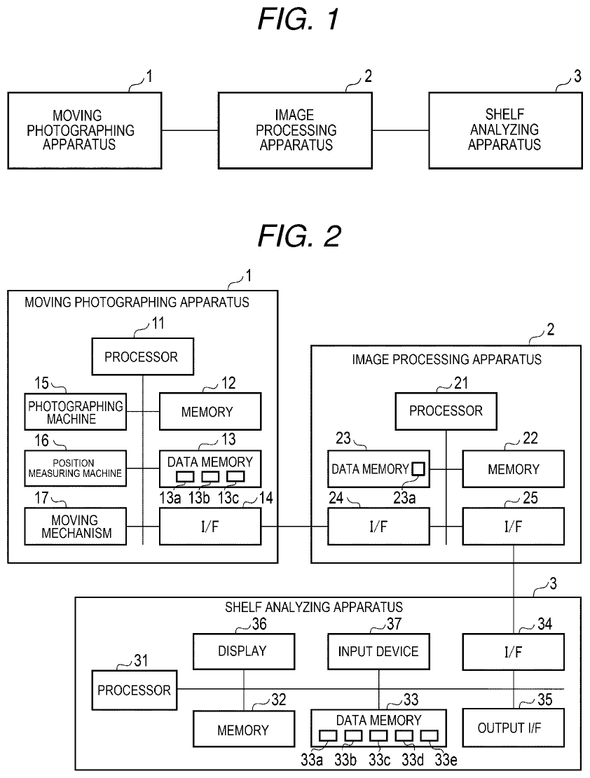

FIG. 1 is a diagram illustrating a configuration example of the image processing system functioning as the shelf management system according to the first embodiment.

The shelf management system (the image processing system) is configured by a moving photographing apparatus 1, an image processing apparatus 2, a shelf analyzing apparatus 3, and the like. The moving photographing apparatus 1 is an apparatus that photographs a plurality of images while moving. The moving photographing apparatus 1 photographs images while moving along shelves (commodity shelves) on which commodities are disposed to photograph images of a continuous plurality of commodity shelves. If the moving photographing apparatus 1 photographs an image, the moving photographing apparatus 1 generates a photographed image, photographing position information indicating a photographing position, and photographing condition information indicating other photographing conditions (photographing time, a photographing distance, a photographing condition, and the like). The moving photographing apparatus 1 saves, every time the moving photographing apparatus 1 photographs an image (at every photographing time), a photographed image, photographing position information, and photographing information in a storage device in association with one another. The moving photographing apparatus 1 supplies, at every photographing time, information (photographed image information) such as the photographed image, the photographing position information, and the photographing information associated with one another to the image processing apparatus 2.

The image processing apparatus 2 acquires, together with the photographed image, the information such as the photographing position information and the photographing condition information corresponding to the photographed image from the moving photographing apparatus 1. The image processing apparatus 2 performs image processing of the photographed image acquired from the moving photographing apparatus 1 based on the information such as the photographing position information acquired together with the photographed image. The image processing apparatus 2 recognizes objects such as commodities and shelf labels present in a commodity shelf from a plurality of photographed images and generates information concerning the objects in the commodity shelf included in the photographed images. The image processing apparatus 2 outputs data indicating a result of the image processing to the shelf analyzing apparatus 3.

The shelf analyzing apparatus 3 acquires, from the image processing apparatus 2, the data indicating the result of the image processing for the photographed images photographed by the moving photographing apparatus 1. The shelf analyzing apparatus 3 performs processing for analyzing data concerning the shelf based on the data indicating the result of the image processing acquired from the image processing apparatus 2. For example, the shelf analyzing apparatus 3 performs generation of shelf allocation information indicating disposition of commodities in commodity shelves in a store, collation with existing shelf allocation information, collation of shelf allocation related information (confirmation of commodity stored in the shelves), and the like.

FIG. 2 is a block diagram illustrating a configuration example of the apparatuses configuring the shelf management system according to the first embodiment.

In the configuration example illustrated in FIG. 2, the moving photographing apparatus 1 includes a processor 11, a memory 12, a data memory 13, an interface (I/F) 14, a photographing machine 15, a position measuring machine 16, and a moving mechanism 17.

The processor 11 controls the moving photographing apparatus 1. The processor 11 executes programs to thereby realize various kinds of processing. The processor 11 is, for example, a CPU. The processor 11 executes programs stored by the memory 12 or the data memory 13 to thereby realize operation control, data processing, and the like of the units.

The memory 12 is configured by various memory devices. For example, the memory 12 includes memory devices such as a RAM, a ROM, and an NVM. The RAM functions as a volatile working memory and temporarily retains various data. The ROM is a nonvolatile memory and stores programs, control data, and the like. The NVM is a rewritable nonvolatile memory and stores programs, control data, and the like.

The data memory 13 stores various data. The data memory 13 is configured by a rewritable storage device such as a HDD (hard disk drive) or an SSD (solid state drive). The data memory 13 includes a storage region 13a that stores the photographed image, a storage region 13b that stores the photographing position information, and a storage region 13c that stores the photographing condition information.

The interface 14 is an interface for communicating with the image processing apparatus 2. The interface 14 transfers the photographed image, the photographing position information, the photographing information, and the like to the image processing apparatus 2. The interface 14 may be an interface that performs information transmission by wire or may be an interface that performs information communication by wireless transmission. The interface 14 receives an input of information via an information input terminal such as a USB (universal serial bus), a LAN (local area network) port, or a wireless antenna.

The photographing machine 15 photographs an image. The photographing machine 15 is, for example, a camera. The image photographed by the photographing machine 15 is stored in the storage region 13a as a photographed image. The position measuring machine 16 measures a position where the image is photographed. The position measuring machine 16 specifies, as a photographing position, a position at the time when the photographing machine 15 photographs the image. Information indicating the photographing position is stored in the storage region 13as photographing position information. For example, the photographing machine 15 and the position measuring machine 16 associate, in operations synchronized by synchronization processing, the photographed image photographed by the photographing machine 15 and the photographing position information during the photographing execution.

The moving mechanism 17 is a mechanism that moves a housing mounted with the units of the moving photographing apparatus 1. For example, the moving mechanism 17 moves the housing of the moving photographing apparatus 1 with power from an electric motor such as a motor, the operation of which is controlled by the processor 11. The moving mechanism 17 may have a configuration for moving the housing with manpower.

In the configuration example illustrated in FIG. 2, the image processing apparatus 2 includes a processor 21, a memory 22, a data memory 23, an interface (I/F) 24, and an interface (I/F) 25.

The processor 21 manages control, data processing, and the like of the image processing apparatus 2. The processor 21 executes programs to thereby realize various kinds of processing. The processor 21 is, for example, a CPU. The processor 21 executes programs stored in the memory 22 or the data memory 23 to thereby realize operation control, data processing, and the like of the units.

The memory 22 is configured by various memory devices. For example, the memory 22 includes memory devices such as a RAM, a ROM, and an NVM. The RAM functions as a volatile working memory and temporarily retains various data. The ROM is a nonvolatile memory and stores programs, control data, and the like. The NVM is a rewritable nonvolatile memory and stores programs, control data, and the like.

The data memory 23 stores various data. The data memory 23 is configured by a rewritable nonvolatile storage device such as a HDD or an SSD. The data memory 23 includes a storage region 23a that stores an image set as a reference (a reference image) in order to process a photographed image. However, the reference image may be stored in, for example, the RAM of the memory 22.

The interface 24 is an interface for communicating with the moving photographing apparatus 1. The interface 24 functions as an input interface that receives the photographed image, the photographing position information, the photographing condition information, and the like from the moving photographing apparatus 1. The interface 25 is an interface for communicating with the shelf analyzing apparatus 3. The interface 25 transfers, for example, a result of image processing to the shelf analyzing apparatus 3.

The interface 24 and the interface 25 may be interfaces that perform information transmission by wire or may be interfaces that perform information communication by wireless transmission. The interface 24 and the interface 25 receive an input of information via an information input terminal such as a USB, a LAN port, or a wireless antenna. The interface 24 and the interface 25 may be configured as one communication unit.

In the configuration example illustrated in FIG. 2, the shelf analyzing apparatus 3 includes a processor 31, a memory 32, a data memory 33, an interface (I/F) 34, an output interface (I/F) 35, and a display 36.

The processor 31 manages control, data processing, and the like of the shelf analyzing apparatus 3. The processor 31 executes programs to thereby realize various kinds of processing. The processor 31 is, for example, a CPU. The processor 31 executes programs stored by the memory 32 or the data memory 33 to thereby realize operation control, data processing, and the like of the units.

The memory 32 is configured by various memory devices. For example, the memory 32 includes memory devices such as a RAM, a ROM, and an NVM. The RAM functions as a volatile working memory and temporarily retains various data. The ROM is a nonvolatile memory and stores programs, control data, and the like. The NVM is a rewritable nonvolatile memory and stores programs, control data, and the like.

The data memory 33 stores various data. The data memory 33 is configured by a rewritable nonvolatile storage device such as a HDD (hard disk drive) or an SSD (solid state drive). The data memory 33 includes storage regions 33a to 33e for storing various data.

The interface 34 is an interface for communicating with the image processing apparatus 2. The interface 34 functions as an input interface that receives, for example, data indicating a result of image processing from the image processing apparatus 2. The output interface 35 is an interface for outputting a processing result by the shelf analyzing apparatus 3 to an external apparatus.

The interface 34 and the interface 35 may be interfaces that perform information transmission by wire or may be interfaces that perform information communication by wireless transmission. The interface 34 and the interface 35 receive an input of information and output information via an information input terminal such as a USB, a LAN port, or a wireless antenna. The interface 34 and the interface 35 may be configured as one communication unit.

The display 36 is a display device that displays information. For example, the display 36 displays a processing result by the shelf analyzing apparatus 3 on a display screen. An input device 37 is a device for an operator to input information. The input device 37 is configured by a keyboard, a touch panel, or the like. For example, the display 36 and the input device 37 may be configured as a display device with a touch panel. The storage regions 33a to 33e of the data memory 33 are configured as databases that store various data.

For example, the storage region 33a functions as a commodity shelf database. The commodity shelf database stores, concerning commodity shelves present in the store, information such as types, sizes, the numbers of stages, depths of the stages, and heights of the shelves as commodity shelf information.

The storage region 33b functions as a commodity database. The commodity database stores, for each of commodities, information necessary for shelf allocation such as types, package sizes, prices, and stock quantities of the commodities as commodity information.

The storage region 33c functions as a store layout database. The store layout database stores information related to a map in the store such as a plan view of the store and disposition of the commodity shelves as store layout data.

The storage region 33d functions as a commodity master. The commodity master stores information equivalent to shelf allocation related information not included in the shelf allocation information itself but closely related to the shelf allocation information. For example, the commodity master stores, for each of the commodities, information such as prices, stock quantities, the numbers of orders, and best before dates as the information equivalent to the shelf allocation related information.

The storage region 33e functions as a shelf allocation database. The shelf allocation database stores shelf allocation information indicating commodities disposed in the commodity shelves in the store. The shelf allocation database may be rewritten to information indicating shelf allocation created by processing explained below.

Apart or all of the databases stored in the storage regions 33a to 33e may be provided in a memory of the external apparatus. That is, the databases may be provided in a data server accessible from the shelf management system. If the databases are provided in the memory of the external apparatus, an input and output interface for accessing the external apparatus including the database is provided in the shelf analyzing apparatus 3.

The moving photographing apparatus 1, the image processing apparatus 2, and the shelf analyzing apparatus 3 maybe combined as appropriate and realized by the same housing. For example, the moving photographing apparatus 1 and the image processing apparatus 2 may be realized as one housing. The image processing apparatus 2 and the shelf analyzing apparatus 3 may be realized by one housing.

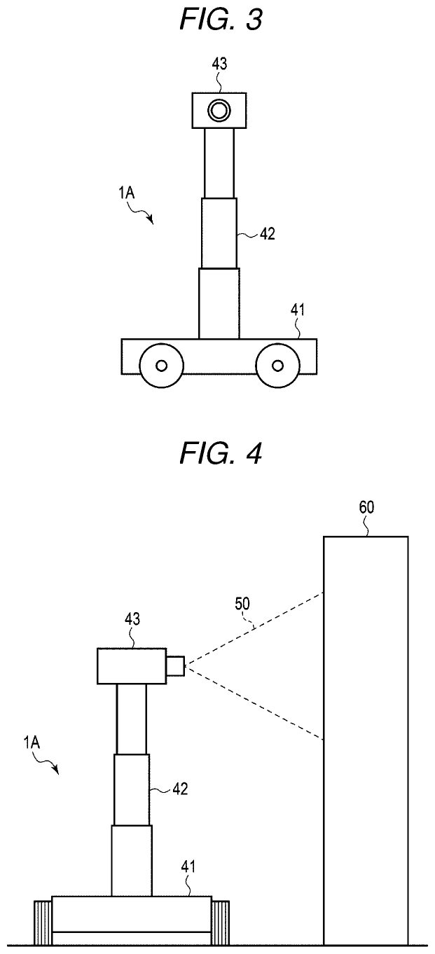

A configuration example of the moving photographing apparatus 1 (1A) according to the first embodiment is explained. FIGS. 3 and 4 are exterior views illustrating the configuration of a moving photographing apparatus 1A, which is a configuration example of the moving photographing apparatus 1 according to the first embodiment.

The moving photographing apparatus 1A illustrated in FIGS. 3 and 4 is a photographing apparatus of an autonomous mobile type (a mobile robot for shelf photographing) that autonomously moves in a store and performs photographing of commodity shelves. The moving photographing apparatus 1A illustrated in FIGS. 3 and 4 may be mounted with the image processing apparatus 2 or may be mounted with the image processing apparatus 2 and the shelf analyzing apparatus 3.

As illustrated in FIGS. 3 and 4, the moving photographing apparatus 1A includes a truck 41, a pole 42, and a camera 43. Further, the moving photographing apparatus 1A is mounted with a control unit including the processor 11, the memory 12, the data memory 13, the interface (I/F) 14, the position measuring machine 16, and the moving mechanism 17.

The truck 41 is provided with wheels and the like driven by the moving mechanism 17 including a driving motor. The truck 41 autonomously moves according to control by the processor 11.

One end portion (the lower end portion) of the pole 42 is fixed on the truck 41 in a state in which the pole 42 is erected in the vertical direction. The pole 42 is configured to be telescopic by the moving mechanism 17 controlled by the processor 11. Since the lower end portion of the pole 42 is fixed to the truck 41, the upper end portion (the distal end portion) of the pole 42 moves in the up-down direction according to extension and retraction. For example, the upper end portion (the distal end portion) moves upward if the pole 42 extends. The upper end portion (the distal end portion) moves downward if the pole 42 retracts.

The camera 43 is an example of the photographing machine 15. The camera 43 is set at the distal end portion (the upper end portion) of the pole 42. Therefore, the camera 43 moves in the horizontal direction (the lateral direction with respect to a commodity shelf) according to the movement of the truck 41 and moves in the vertical direction (the up-down direction with respect to the commodity shelf) according to the extension and retraction of the pole 42. The camera 43 has a specific photographing range 50. The camera 43 photographs an image in the photographing range 50 according to a photographing command from the processor 11.

In the configuration example illustrated in FIG. 4, the camera 43 is set to face the front side of a commodity shelf 60. The photographing range 50 of the camera 43 moves in the lateral direction according to the movement of the truck 41 and moves in the up-down direction according to the extension and retraction of the pole 42. For example, the photographing range 50 of the camera 43 is set to move on the front side of the commodity shelf 60 if the truck 41 moves in parallel along the commodity shelf 60. With the configuration explained above, the camera 43 can photograph the entire front sides in commodity shelves 60 according to the movement of the truck 41 and the extension and retraction of the pole 42.

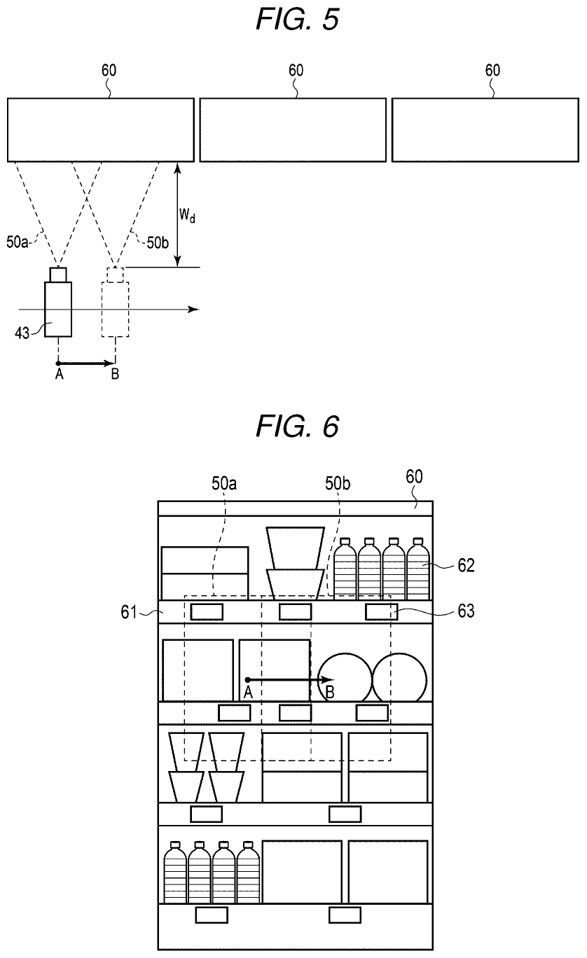

FIG. 5 is a diagram for explaining a relation between the photographing range 50 of the camera 43 in the moving photographing apparatus 1A and the commodity shelf 60.

A surface on the front side of the commodity shelf 60 (a surface on a side where commodities are displayed to be visually inspectable) is set as a photographing target surface of the camera 43. The moving photographing apparatus 1A moves the truck 41 such that a photographing direction of the camera 43 faces photographing target surfaces of the commodity shelves 60 in the store. In the first embodiment, it is assumed that the moving photographing apparatus 1A controls the truck 41 to move to keep the distance from the camera 43 to the photographing target surface (a photographing distance to the commodity shelf 60) constant. The moving photographing apparatus 1A moves the truck 41 in parallel to the front of the commodity shelf 60 while keeping a photographing distance (a working distance; Wd) from the camera 43 to the photographing target surface constant.

In an example illustrated in FIG. 5, the camera 43 of the moving photographing apparatus 1A photographs the photographing target surface at the photographing distance Wd in a photographing position A. After photographing an image in the photographing position A, the moving photographing apparatus 1A moves the truck 41 while keeping the photographing distance Wd. The camera 43 executes photographing in a photographing position B.

FIG. 6 is a diagram for explaining a relation between a disposition state of commodities in the commodity shelf 60 and a photographing range of the camera 43.

In an example illustrated in FIG. 6, the commodity shelf 60 includes four shelf stages (shelf plates) 61. Various commodities 62 are displayed on the shelf stages 61. Shelf labels (shelf tags) 63 are posted on the front side of the shelf stages 61. In FIG. 6, a photographing range photographed by the camera 43 in the photographing position A and a photographing range photographed by the camera 43 in the photographing position B are illustrated by dotted lines. In FIG. 6, the photographing range in the photographing position A and the photographing range in the photographing position B overlap in a part of a region. Therefore, the camera 43 photographs, in the photographing position A and the photographing position B, photographed images in which a part of the commodities and a part of the shelf labels overlap.

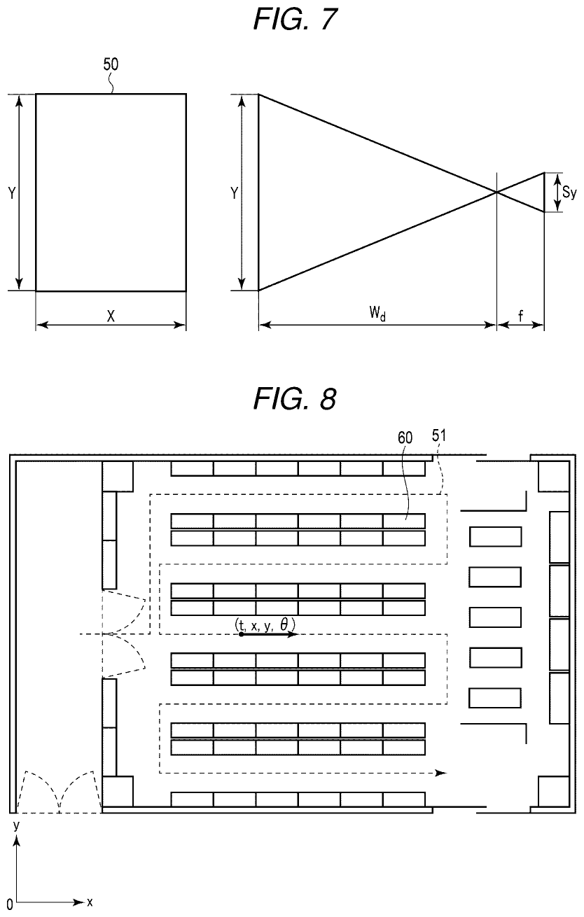

FIG. 7 is a schematic diagram for explaining an example in which width X and height Y of the photographing range 50 are simply calculated.

In FIG. 7, information acquired as photographing condition information if the camera 43 photographs an image is illustrated. Image sensor sizes of the camera 43 are represented as Sx (a size in an x direction of an image sensor) and Sy (a size in a y direction of the image sensor). A focal length of a lens of the camera 43 is represented as f [mm]. In this case, the width X and the height Y are approximately calculated by the following expression.

X=Wd·Sx/f

Y=Wd·Sy/f

That is, if the lens focal length f, the image sensor sizes Sx and Sy, and the photographing distance Wd are given as photographing conditions, it is possible to approximately calculate the photographing range 50.

FIG. 8 is a plan view schematically illustrating an example of a layout in a store in which a plurality of commodity shelves are disposed.

The moving photographing apparatus 1A of the autonomous mobile type according to the first embodiment has, as a map, an intra-store layout illustrated in FIG. 8 and moves according to a set route 51. According to the route 51 illustrated in FIG. 8, the moving photographing apparatus 1A moves in a state in which the commodity shelves 60 set in the store can be photographed by the camera 43. In the map set in the moving photographing apparatus 1A of the autonomous mobile type, position information in the map is indicated by a two-dimensional coordinate and a direction (a direction component) in a plan view.

For example, the moving photographing apparatus 1A adds time information “t”0 to the position information indicating a position on the map and records the position information and the time information “t”0 as photographing position information synchronized with a photographed image. Consequently, the moving photographing apparatus 1A is capable of specifying which commodity shelf 60 is photographed from which position in the store to obtain the photographed image. A coordinate system obtained by adding a height direction to a two-dimensional coordinate in the plan view serving as the position information in the map in the store functions as a global coordinate system representing a photographing position in the store.

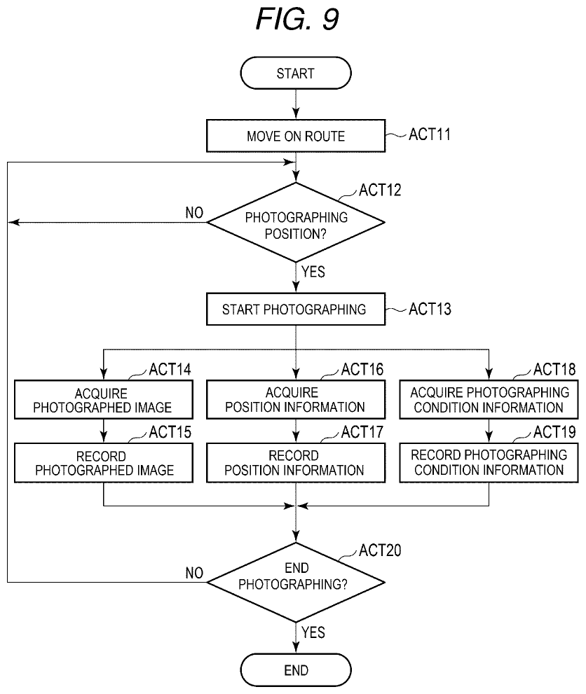

FIG. 9 is a flowchart for explaining an operation example of the moving photographing apparatus 1A of the autonomous mobile type according to the first embodiment.

In the moving photographing apparatus 1A of the autonomous mobile type, map information in the store and route information indicating a moving route in the store are set in order to photograph the commodity shelves in the store. The processor 11 moves, based on the moving route, the photographing range by the camera 43 functioning as the photographing machine 15 (ACT 11). For example, the processor 11 causes the moving mechanism 17 to move the truck 41 based on the route information. The movement with the truck 41 is movement in a plane direction in the store in which the commodity shelves are disposed. The processor 11 extends and retracts the pole 42 to thereby move the photographing range of the camera 43 in the up-down direction.

After starting the movement of the truck 41, the processor 11 determines, based on, for example, position information measured by the position measuring machine 16, whether the camera 43 reaches a photographing position (ACT 12). For example, the processor 11 executes photographing in a photographing position set on the route. The processor 11 may execute photographing at every specific interval (time interval, moving distance interval, etc.) while moving on the route at predetermined speed.

If the camera 43 reaches the photographing position (YES in ACT 12), the processor 11 starts photographing processing performed using the camera 43 functioning as the photographing machine 15 (ACT 13). The processor 11 executes, as photographing processing, processing such as photographing of an image by the camera 43, specifying of a photographing position where the image is photographed, and acquisition of photographing condition information. The processor 11 executes, as time synchronized processing synchronized with time, processing included in the photographing processing such as acquisition of a photographed image by the camera 43, specifying of a photographing position, and acquisition of photographing condition information. The processor 11 manages the photographed image, the photographing position information, and the photographing condition information as photographed image information associated with a photographed image ID (identification information).

That is, if determining that the camera 43 reaches the photographing position (if starting the photographing processing), the processor 11 sends an image photographing command to the camera 43 (ACT 14). The camera 43 photographs an image according to the photographing command sent from the processor 11. If the camera 43 photographs the image, the processor 11 stores a photographed image photographed by the camera 43 in the storage region 13a of the data memory 13 (ACT 15). For example, the processor 11 stores the photographed image acquired from the camera 43 in the storage region 13a in association with identification information (a photographed image ID) for identifying, for each photographing processing, the photographed image acquired from the camera 43.

Simultaneously with sending the photographing command to the camera 43, the processor 11 performs processing for acquiring a photographing position at the time when the camera 43 photographs an image (ACT 16). The processor 11 specifies, based on position information measured by the position measuring machine 16, the photographing position at the time when the camera 43 photographs the image. In supplying the photographing command to the camera 43 if the camera 43 reaches a predetermined photographing position on the route, the processor 11 may set, as the photographing position, a position at the time when the processor 11 outputs the photographing command to the camera 43. If the truck 41 moves on the route at constant moving speed, the processor 11 may calculate the photographing position according to movement start time and an elapsed time from a route start position. In photographing an image at a predetermined time interval while moving on the route, the processor 11 may specify the photographing position from moving speed and a photographing time interval.

The processor 11 sets information indicating the specified photographing position as photographing position information. If the photographing position information is acquired, the processor 11 saves the photographing position information associated with the photographed image in the storage region 13b of the data memory 13 (ACT 17). For example, the processor 11 stores the photographing position information in the storage region 13b in association with identification information (a photographed image ID) for each photographing processing.

The processor 11 supplies the photographing command to the camera 43 and performs processing for acquiring photographing condition information related to an image photographed by the camera 43 (ACT 18). The processor 11 acquires, from the camera 43, photographing condition information such as a distance (a photographing distance) from the camera 43 to the front of the commodity shelf 60 set as a photographing target, photographing time, and photographing conditions.

For example, the photographing conditions may include the image sensor sizes Sx and Sy, the focal length f, and the like of the camera 43 shown in FIG. 7. The processor 11 may calculate the photographing distance Wd from the photographing position information and the position of the commodity shelf set as the photographing target. The processor 11 may acquire a photographing distance from the camera 43 or may specify a photographing distance according to a detection result of a separately provided sensor.

If the photographing condition information is acquired, the processor 11 saves the photographing condition information associated with the photographed image in the storage region 13c of the data memory 13 (ACT 19). For example, the processor 11 stores the photographing condition information in the storage region 13c in association with the identification information (the photographed image ID) for each photographing processing.

If a route, a distance of which to a commodity shelf is fixed, is set, the processing for recording the photographing distance Wd as the photographing condition information may be omitted if movement accuracy of the moving photographing apparatus 1A is high. This is because the photographing distance Wd is a constant fixed value if the moving photographing apparatus 1A highly accurately moves on the route, the distance of which to the commodity shelf is fixed.

Every time the photographing processing ends once, the processor 11 determines whether to end the photographing (ACT 20). That is, if the photographed image, the photographing position information, and the photographing condition information are stored in the data memory 13 in association with one another, the processor 11 determines whether the next image should be photographed. If the next photographing is executed (YES in ACT 20), the processor 11 returns to ATC 11, continues the movement, and moves to the next photographing position.

According to the processing explained above, the moving photographing apparatus 1A photographs the commodity shelf in a plurality of photographing positions. The moving photographing apparatus 1A acquires, in every photographing, information (photographed image information) in which a photographed image, photographing position information, and photographing condition information are associated. The moving photographing apparatus 1A stores the photographed image, the photographing position information, and the photographing condition information in every photographing in the data memory 13 in association with one another. The moving photographing apparatus 1A transmits a plurality of photographed images stored in the data memory 13 to the image processing apparatus 2 together with photographing position information and photographing condition information related to the photographed images. Consequently, the moving photographing apparatus 1A can supply the plurality of photographed images, which are obtained by photographing the entire commodity shelf for a plurality of times, and the information related to the photographed images to the image processing apparatus 2.

The moving photographing apparatus 1A may transfer, in every photographing, on a real-time basis, the photographed image, the photographing position information, and the photographing condition information to the image processing apparatus 2. In this case, the processor 11 only has to execute processing for transferring the photographed image, the photographing position information, and the photographing condition information to the image processing apparatus 2 instead of the processing in ACTS 15, 17, and 19 explained above.

The operation of the image processing apparatus 2 according to the first embodiment is explained.

First, processing for the photographed image information including the photographed image acquired from the moving photographing apparatus 1A by the image processing apparatus 2 according to the first embodiment is explained.

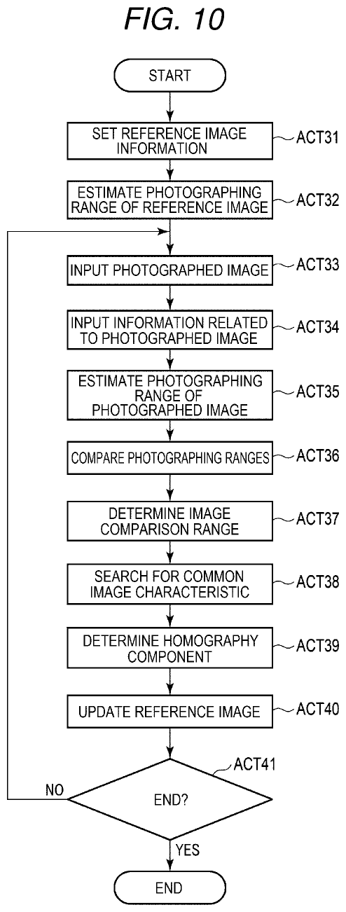

FIG. 10 is a flowchart for explaining, as image processing in the image processing apparatus 2, an operation example in which the photographed image information from the moving photographing apparatus 1A is processed.

In the first embodiment, it is assumed that the image processing apparatus 2 is configured as an apparatus separate from the moving photographing apparatus 1 (the moving photographing apparatus 1A of the autonomous mobile type) as illustrated in FIG. 1. It is assumed that the image processing apparatus 2 acquires the photographed image, the photographing position information, and the photographing condition information recorded in the data memory 13 by the moving photographing apparatus 1A according to the processing explained above. For example, it is assumed that, as so-called off-line processing, the image processing apparatus 2 acquires the photographed image, the photographing position information, and the photographing condition information from the moving photographing apparatus 1A.

First, as initial setting, the processor 21 of the image processing apparatus 2 sets reference image information including a reference image set as a reference of the image processing (ACT 21). The reference image information is information including a photographed image selected as the reference image and photographing position information and photographing condition information at the time when the photographed image is photographed. The processor 21 stores the reference image information in the storage region 23a of the data memory 23 to thereby set the reference image information. As the reference image in the initial setting, for example, a photographed image photographed by the moving photographing apparatus 1A in a first photographing position in a set route can be used.

If the reference image information is set, the processor 21 sets a photographing range of the reference image included in the reference image information (ACT 22). For example, according to the relation explained with reference to FIGS. 5 and 7, the photographing range of the reference image can be calculated using information such as a photographing distance included in the photographing condition information. That is, the processor 21 estimates, based on the reference image information, the photographing range of the reference image from information associated with the reference image.

If the reference image and the photographing range of the reference image are set, the processor 21 receives an input of a photographed image set as a target of the image processing (ACT 33). For example, as the photographed image set as the target of the image processing, a photographed image photographed next to the photographed image set as the reference image is used. However, a photographed image several frames after the photographed image set as the reference image may be set as the photographed image set as the target of the image processing. In first image processing, as initial setting, the same photographed image as the photographed image selected as the reference image may be set as the photographed image set as the target of the image processing.

Simultaneously with receiving the input of the photographed image set as the target of the image processing, the processor 21 receives an input of photographing position information and the photographing condition information corresponding to the photographed image set as the target of the image processing (ACT 34). In the first embodiment, it is assumed that the moving photographing apparatus 1 stores a plurality of photographed images and photographing position information and photographing condition information corresponding to the photographed images in the data memory 13 according to the operation explained above. Therefore, the processor 21 acquires the photographed image set as the target of the image processing and the photographing position information and the photographing condition information corresponding to the photographed image from the moving photographing apparatus 1.

If the photographed image set as the target of the image processing (hereinafter referred to as target image) is input, the processor 21 calculates a photographing range of the target image (ACT 35). The processor 21 can calculate the photographing range of the target image according to the same method as the method of calculating the photographing range of the reference image.

If the photographing range of the target image is calculated, the processor 21 compares the photographing range of the reference image and the photographing range of the target image (ACT 36). The processor 21 calculates a geometrical overlapping region based on photographing position information and the photographing ranges of the reference image and the target image. For example, an overlapping region of the photographed image in the photographing position A and the photographed image in the photographing position B is geometrically calculated as illustrated in FIGS. 5 and 6.

In order to efficiently compare both the photographing ranges, the processor 21 determines a range in which an image feature value included in the reference image and an image feature value included in the target image are compared (an image comparison range) (ACT 37). In order to efficiently compare the reference image and the target image, the processor 21 limits the range in which the image feature values in both the images are compared.

If the image comparison range is determined, the processor 21 performs matching processing of the reference image and the target image in the image comparison range (ACT 38). As the matching processing, the processor 21 extracts local feature values included in both of the reference image and the target image. If the local feature values are extracted from the reference image and the target image, the processor 21 performs matching of the local feature value of the reference image and the local feature value of the target image and searches for a common image characteristic.

The processor 21 determines a photographing range and a homography component concerning the target image based on a result of the matching processing of the reference image and the target image (ACT 39). The processor 21 can calculate a photographing range of the target image from the reference image information according to the matching of the reference image and the target image. The processor 21 can calculate, based on the matching of the reference image and the target image, a range of geometrical overlap of the photographed image on the reference image according to homography matrix calculation.

The photographing position information and the photographing ranges in the reference image and the photographed image are already roughly grasped from the photographing position information and the photographing information. Therefore, the processor 21 is capable of determining whether the calculated homography matrix satisfies an appropriate condition. If there is a marked deviation in a calculation result of the homography matrix, the processor 21 may readjust parameters and recalculate a homography matrix.

If the photographing range and the homography component of the target image are determined, the processor 21 updates the reference image (ACT 40). For example, the processor 21 updates the reference image to the photographed image set as the target image. In this case, the processor 21 updates the reference image information to the photographed image information including the photographing position information and the photographing condition information of the photographed image set as the target image. The processor 21 updates the photographing range of the reference image to the photographing range of the photographed image set as the target image. If there is the next photographed image set as the target of the image processing (YES in ACT 41), the processor 21 returns to ACT 33 and executes the processing explained above on the next photographed image.

According to the processing explained above, the image processing apparatus 2 obtains the photographing ranges of the photographed images and the homography component for the reference image. If the photographed images are set as the reference image in photographing order and the photographed image photographed next to the reference image is set as the target image, homography components among the photographed images photographed in order are obtained.

Processing for acquiring data necessary for analyzing information concerning a commodity shelf photographed in a photographed image is explained.

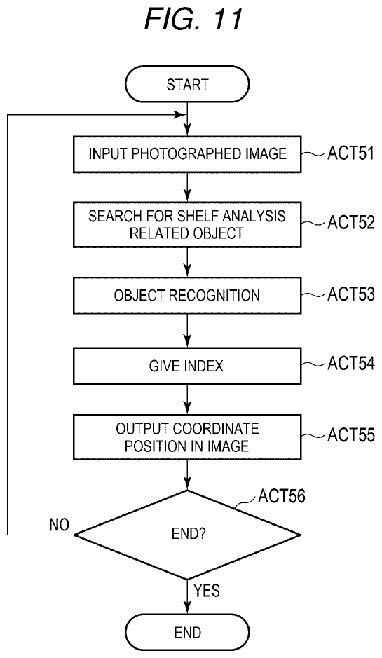

FIG. 11 is a flowchart for explaining, as the image processing by the image processing apparatus 2, an operation example of processing for acquiring data for analyzing a commodity shelf from a photographed image.

The processor 21 of the image processing apparatus 2 receives an input of a photographed image set as a processing target (ACT 51). If the photographed image set as the target is input, the processor 21 analyzes, concerning a commodity shelf photographed in the photographed image, components such as displayed commodities, shelf labels, and shelf stages according to image recognition processing. The components present in the commodity shelf such as the displayed commodities, the shelf labels, and the shelf stages are collectively referred to as objects.

That is, the processor 21 performs searching processing for searching for objects related to an analysis of the shelf from the photographed image input as the processing target (ACT 52). As the search processing for the objects, the processor 21 detects objects present in the photographed image and segments image regions of the detected objects. If the objects are detected, the processor 21 executes object recognition processing on the image regions of the detected objects (ACT 53).

The processing in ACTS 52 and 53 only has to be processing in which all the objects present in the photographed image can be recognized. That is, as the processing in ACTS 52 and 53, various methods and processing can be applied according to a type of an object set as a target of recognition and a method of recognition. For example, the processor 11 may successively pursue, in the photographed image, according to iterative processing, accuracy of region segmentation of a boundary region of labels posted on a package of a commodity or a shelf. The processor 11 may segment a region of a barcode described on an object such as a commodity or a label and recognize the object according to decode processing of the barcode. The processor 11 may segment, for each of regions, a management code or a character string described on the object and recognize the object according to OCR processing for the segmented region.

If the object is recognized from the photographed image, the processor 21 gives a reference number (an index) to the recognized object (ACT 54). It is assumed that an index serving as a reference number in the photographed image is given to the object. Further, the processor 21 calculates position information indicating a position of the recognized object (ACT 55). The processor 21 specifies a representative point of the recognized object and calculates, as position information, a position coordinate based on a position of the representative point in the photographed image. The processor 21 manages the reference number of the recognized object and the position information of the object in association with each other.

The input processing for the photographed image in ACT 51 explained above is equivalent to the input processing (ACT 33) for the photographed image in FIG. 10. Therefore, the processor 21 may execute the processing in ACTS 33 to 40 illustrated in FIG. 10 and the processing in ACTS 51 to 55 illustrated in FIG. 11 in parallel.

Processing for uniquely specifying objects present in a plurality of photographed images is explained.

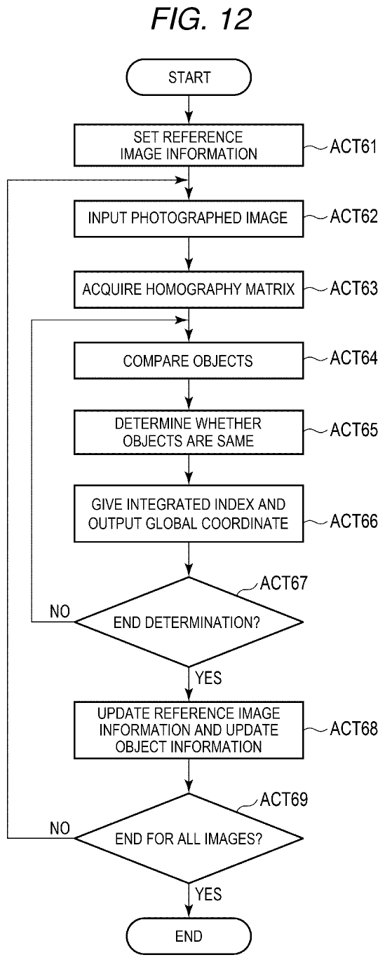

FIG. 12 is a flowchart for explaining, as the image processing by the image processing apparatus 2, processing for comparing the objects of the photographed images and objects of other photographed images.

The processing illustrated in FIG. 12 is processing for determining whether the objects included in the photographed images are the same as objects included in photographed images before and after the photographed images. The processing illustrated in FIG. 12 is carried out as processing in a post stage following the processing (the object recognition processing) illustrated in FIG. 11.

First, as initial setting, the processor 21 sets reference image information (ACT 61). The setting of the reference image information may be the same as the processing in ACT 31 illustrated in FIG. 10 explained above. After setting the reference image information, the processor 21 receives an input of a photographed image set as a processing target (a target image) (Act 62). For example, as the target image, a photographed image photographed next to the reference image (a photographed image, a photographing region of which is adjacent to (partially overlapping) the reference image) is input.

If the target image is input, the processor 21 acquires a homography matrix between the reference image and the target image (ACT 63). The homography matrix can be calculated by the processing illustrated in FIG. 10. It is assumed that a homography matrix serving as a result already calculated by the executed processing illustrated in FIG. 10 is acquired.

If the homography matrix between the reference image and the target image is acquired, the processor 21 compares an object included in the target image and an object included in the reference image (ACT 64). The processor 21 estimates, based on position information and homography matrix information of the object in the target image, a position where the object is present in the reference image. That is, the processor 21 calculates, concerning the objects, a positional relation between positions in the target image and positions in the reference image. The processor 21 searches, based on the calculated positional relation, whether a similar object is present in a position equivalent to the reference image. For example, the processor 21 refers to the positional relation between the target image and the reference image and searches whether an object similar to an object recognized as a shelf label in the target image is present in the reference image.

If an object similar to the object of the search target is found from the reference image, the processor 21 determines from a coincidence degree of position information of both the images whether the objects are the same (ACT 65). The processor 21 determines from a coincidence degree of a position of the object of the search target in the target image and a position of the similar object found from the reference image whether the objects are the same.

The processor 21 gives a reference number to the object of the target image and specifies a global coordinate according to presence or absence of the same object in the reference image (ACT 66). If determining that the same object is present in the reference image, the processor 21 gives the same reference number as a reference number of the reference image to the object. Consequently, an integrated reference number (an integrated index) can be given to the objects included the plurality of photographed images. The processor 21 converts the position information of the objects included in the target image from local coordinates in the photographed images to global coordinates. Consequently, position information that can be integrally treated for all the photographed images is specified in the objects included in the plurality of photographed images.

The processor 21 executes the processing in ACTS 64 to 66 on the objects included in the target image. If the processing in ACTS 64 to 66 ends for all the objects included in one target image (YES in ACT 67), the processor 21 updates (sets) the reference image information to the information (the photographed image information) concerning the photographed image set as the processing target for which the processing explained above ends (ACT 68). Simultaneously with updating the reference image information, the processor 21 determines whether the next photographed image is present (ACT 69). If the next photographed image is present (YES in ACT 69), the processor 21 performs the processing in ACTS 62 to 66 on the next photographed image. If the next photographed image is absent (NO in ACT 69), the processor 21 ends the series of processing.

The processing illustrated in FIGS. 10, 11, and 12 can be executed in combination. ACT 62 in FIG. 12 is equivalent to ACT 33 in FIG. 10 and ACT 51 in FIG. 11. ACT 63 in FIG. 12 is equivalent to ACT 39 in FIG. 10. Further, ACT 68 in FIG. 12 is processing including the processing in ACT 68 in FIG. 10. Therefore, the processing illustrated in FIG. 11 and the processing illustrated in FIG. 10 can be carried out in parallel. ACTS 63 to 68 in FIG. 12 can be incorporated and carried out instead of ACTS 39 and 40 in FIG. 10.

A specific example of data obtained by the image processing in the image processing apparatus 2 explained above is explained.

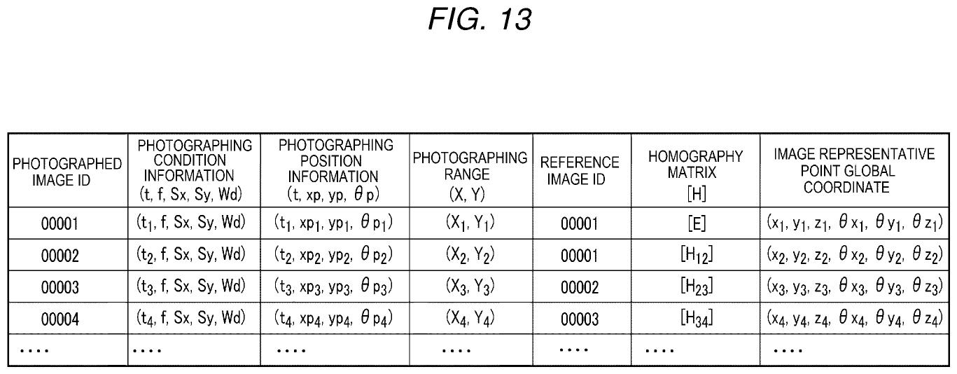

FIG. 13 is a diagram illustrating, in a table format, an example of data obtained in the processing by the image processing apparatus 2 illustrated in FIG. 10.

As explained above, the image processing apparatus 2 acquires the plurality of photographed images photographed by the moving photographing apparatus 1 as the input data (the photographed image information) in which the photographing position information and the photographing condition information are associated for each of the photographed images. The image processing apparatus 2 calculates the photographing ranges for the photographed images based on the geometrical conditions illustrated in FIGS. 5 and 7. The image processing apparatus 2 calculates, for each of the photographed images, the homography matrix for the reference image according to an image correlation with the reference image. Consequently, the image processing apparatus 2 can indicates, with a global coordinate, information indicating positions of the photographed images from the homography matrix and the photographing position information.

In the example illustrated in FIG. 13, a photographed image ID, photographing condition information, photographing position information, a photographing range, a reference image ID, a homography matrix, and a global coordinate of an image representative point are illustrated for each of the photographed images. The information illustrated in FIG. 13 is data for specifying photographing positions, photographing ranges, and the like concerning a plurality of photographed images of commodity shelves in the store photographed by the moving photographing apparatus 1. These kinds of information are data necessary for collating shelf allocations, creating the shelf allocations, and analyzing commodity stocks and the like in the commodity shelves in the store. That is, the image processing apparatus 2 can output data necessary for a shelf analysis for each of the photographed images by acquiring the information illustrated in FIG. 13 according to the processing illustrated in FIG. 10.

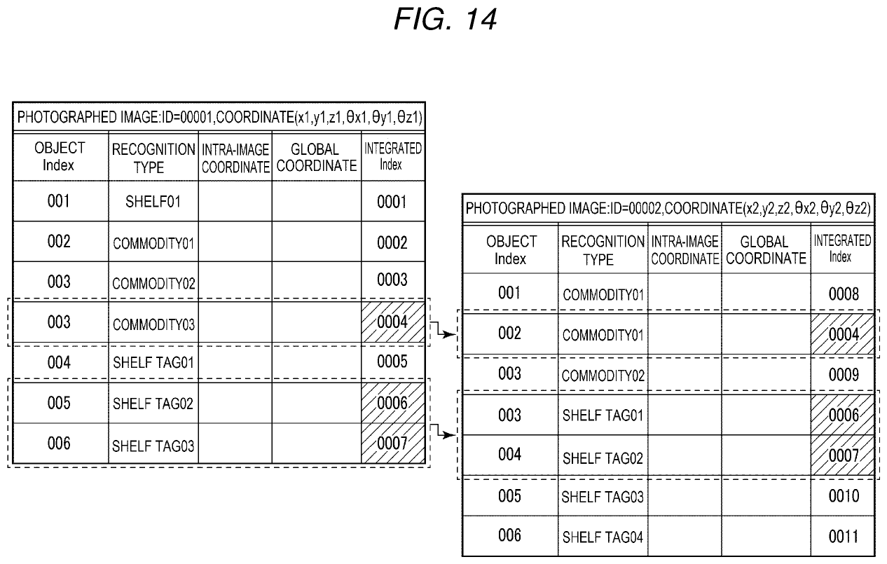

FIG. 14 is a diagram illustrating, in a table format, an example of data concerning the objects in the photographed images obtained in the processing by the image processing apparatus 2 illustrated in FIGS. 11 and 12.

In FIG. 14, an example of information concerning objects in a photographed image with a photographed image ID 00001 (hereinafter described as photographed image 00001) and objects in a photographed image with a photographed image ID 00002 (hereinafter described as photographed image 00002) is illustrated. In the example illustrated in FIG. 14, it is assumed that the photographed image 00001 is set as a reference image for the photographed image 00002. It is assumed that a commodity 02 of the photographed image 00002 and a commodity 03of the photographed image 00001 are determined as the same, a shelf tag 01 of the photographed image 00002 and a shelf tag 02 of the photographed image 00001 are also determined as the same, and a shelf tag 02 of the photographed image 00002 and a shelf tag 03 of the photographed image 00001 are also determined as the same.

The same integrated index (0004) as the commodity 03 of the photographed image 00001 (an object index 004 of the photographed image 00001) determined as the same is given to the commodity 02 of the photographed image 00002 (an object index 002 of the photographed image 00002). The same integrated index (0006) as the shelf tag 02 of the photographed image 00001 determined as the same is given to the shelf tag 01 of the photographed image 00002 (an object index 004 of the photographed image 00002). The same integrated index (0007) as the shelf tag 03 of the photographed image 00001 (an object index 007 of the photographed image 00001) determined as the same is given to the shelf tag 02 of the photographed image 00002 (the object index 003 of the photographed image 00002).

The objects with the object indexes 001, 003, 005, and 006 of the photographed image 00002 are not included in the reference image (the photographed image 00001). New reference numbers are given to these objects as integrated indexes. Global coordinates of the objects are calculated from a global coordinate of the photographed image and a local coordinate in the photographed image.

The operation of the shelf analyzing apparatus 3 is explained.

The shelf analyzing apparatus 3 executes analysis processing of data concerning a shelf based on a result of the image processing by the image processing apparatus 2 explained above. It is assumed that the shelf analyzing apparatus 3 executes, as the analysis processing, processing such as data processing concerning shelf allocation, data processing concerning shelf tags, and data processing concerning inventory management of commodities.

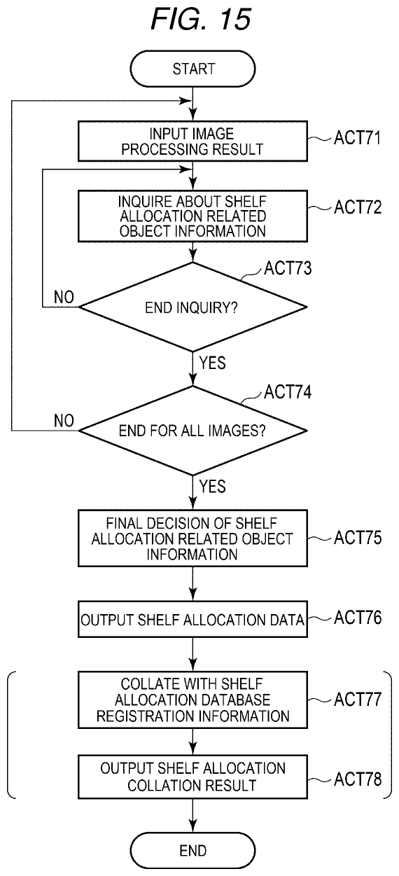

FIG. 15 is a flowchart for explaining the data processing concerning shelf allocation by the shelf analyzing apparatus 3.

The processor 31 of the shelf analyzing apparatus 3 receives, for each of photographed images, an input of an image processing result from the image processing apparatus 2 through the I/F 34 (ACT 71). The image processing result includes information concerning the photographed image such as a photographing position and information concerning objects included in the photographed image. The processor 31 can specify, by referring to the store layout database 33c from photographing position information of the photographed image, a photographed image of which commodity shelf in the store is the photographed image. The processor 31 can specify, by referring to the commodity shelf database 33a, information concerning the commodity shelf such as the number of stages and dimensions in the commodity shelf specified from the photographing position information.

The processor 31 inquires various databases about information concerning objects related to shelf allocation among the objects included in the input photographed image (ACT 72). That is, the processor 31 inquires the various databases about the information concerning the objects related to the shelf allocation to generate shelf allocation information in the photographed image. For example, the processor 31 inquires the commodity database 33b about description content of a shelf label. The processor 31 specifies a commodity indicated by the shelf label from the commodity database 33b and acquires size information and the like of the specified commodity. After acquiring the size information of the commodity, the processor 31 generates commodity information indicating the commodity displayed in the commodity shelf based on position information of the shelf label and the size information of the commodity.

The processor 31 may generate the commodity information using a recognition result of a commodity by the image processing apparatus 2 as the information concerning the object included in the photographed image. In this case, the processor 31 specifies commodity information indicating the commodity from the commodity database 33b based on the recognition result of the commodity. If the commodity information is specified from the commodity database 33b, the processor 31 gives face information or the like to the specified commodity information and generates shelf allocation information.

The processor 31 executes the processing in ACT 72 on the information concerning the objects included in the photographed image. If the inquiry about the objects included in one photographed image ends (YES in ACT 73), the processor 31 returns to ACT 71 until the processing for all the photographed images is completed and executes the processing for the next photographed image.

If the processing for all the photographed images ends (YES in ACT 74), the processor 31 executes final decision processing for the objects related to the shelf allocation (ACT 75). As the final decision processing, the processor 31 checks whether a plurality of objects are present for a component in the same commodity shelf. Consequently, the processor 31 can generate shelf allocation information in the commodity shelves in the store (shelf allocation information of the entire store) based on commodity information (shelf allocation information) obtained from all the photographed images. The processor 31 outputs the shelf allocation information in the entire store after the final decision processing is performed (ACT 76)o. For example, the processor 31 stores, in the shelf allocation database 33e, as new shelf allocation information, shelf allocation information generated from a plurality of photographed images photographed by the moving photographing apparatus 1.

The processor 31 may collate the shelf allocation information (shelf allocation in the present state) generated from the plurality of photographed images photographed by the moving photographing apparatus 1 and the existing shelf allocation information. In performing the collation of shelf allocation, the processor 31 collates the shelf allocation information generated from the plurality of photographed images photographed by the moving photographing apparatus 1 and the shelf allocation information registered in the shelf allocation database 33e (ACT 77). In this case, the processor 31 outputs information indicating a collation result of the generated shelf allocation information and the existing shelf allocation information (ACT 78). For example, the processor 31 displays, on the display 36, as the collation result, information indicating consistency of the generated shelf allocation information and the existing shelf allocation information (e.g., information indicating that the generated shelf allocation information and the existing shelf allocation information are inconsistent).

According to the processing explained above, the shelf analyzing apparatus can generate shelf allocation in the store based on an image processing result for a plurality of photographed images of the commodity shelves in the store photographed by the moving photographing apparatus while moving in the store. The shelf analyzing apparatus can collate the shelf allocation generated based on the image processing result for the plurality of photographed image of the commodity shelves in the store photographed by the moving photographing apparatus while moving in the store and the existing shelf allocation. Consequently, the shelf analyzing apparatus can inform the operator if a present disposition state is different from the existing shelf allocation based on the plurality of photographed images photographed by the moving photographing apparatus while moving in the store.

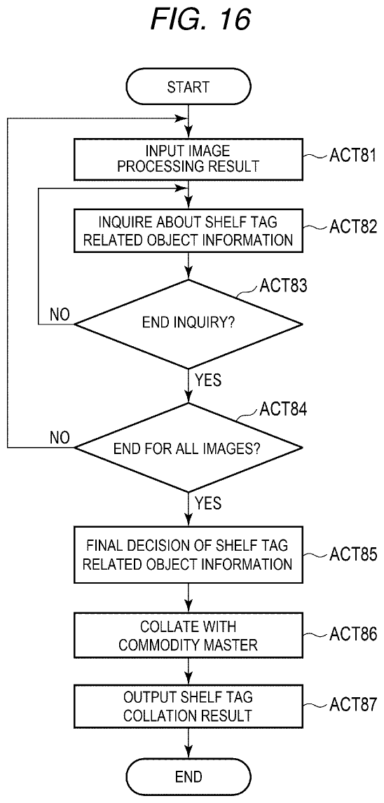

FIG. 16 is a flowchart for explaining an example of data processing concerning a shelf tag by the shelf analyzing apparatus 3.

The processing illustrated in FIG. 16 is processing including processing for collating, rather than shelf allocation information itself, description information described on a shelf label posted in a commodity shelf and registration information of the commodity master 33d.

The processor 31 of the shelf analyzing apparatus 3 receives, for each of photographed images, an input of an image processing result from the image processing apparatus 2 through the I/F 34 (ACT 81). The processor 31 extracts an object concerning the shelf label among objects included in the photographed image (ACT 82). For example, the processor 31 extracts an image region of the object of the shelf label among the objects included in the photographed image and extracts description information of the shelf label from the image region. The description information of the shelf label is information concerning a commodity management code, a commodity name, a price, a before best date, a shelf display period, and the like. The processor 31 extracts the description information of the shelf label according to image recognition and OCR processing for an image of the object in the photographed image. The description information of the shelf label may be information obtained by the image recognition or the OCR processing in the image processing apparatus 2.

If the extraction of the description information of the shelf labels included in one photographed image ends (YES in ACT 83), the processor 31 returns to ACT 81 and executes the same processing on the next photographed image. If the extraction of description information of shelf labels ends concerning all the photographed images (YES in ACT 84), the processor 31 executes final decision processing for the shelf labels (ACT 85). The processor 31 checks whether a plurality of shelf labels are present for a component in the same commodity shelf and specifies description information of shelf labels in the entire store.

If the final decision processing for the shelf labels ends, the processor 31 collates the extracted description information of the shelf label and the information registered in the commodity master 33d (ACT 86). The processor 31 collates the description information of the shelf label and the registration information of the commodity master 33d to thereby check whether the shelf label included in the photographed image is posted in a predetermined position. If the description information of the shelf label and the commodity master 33d are collated, the processor 31 outputs information indicating a collation result of the description information of the shelf label and the registration information of the commodity master 33d (ACT 87). For example, the processor 31 displays, on the display 36, the information indicating the collation result of the description information of the shelf label. The processor 31 may output the collation result of the description information of the shelf label in association with the shelf allocation information. Consequently, the processor 31 is capable of quickly specifying a place where a shelf label indicating a problem is posted.

According to the processing explained above, the shelf analyzing apparatus confirms correctness of shelf labels in the store based on an image processing result for a plurality of photographed images of the commodity shelves in the store photographed by the moving photographing apparatus while moving in the store. The shelf analyzing apparatus outputs information indicating a confirmation result of the correctness of the shelf labels in the store. Consequently, the shelf analyzing apparatus can inform, from the plurality of photographed images photographed by the moving photographing apparatus while moving in the store, the operator whether the shelf labels in the store are correctly posted.

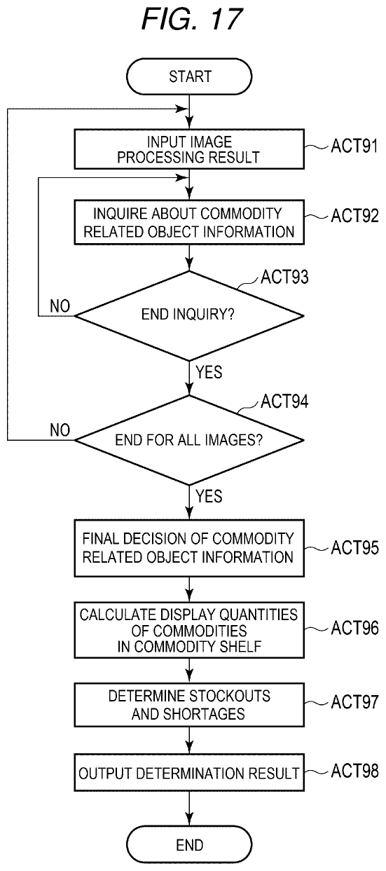

FIG. 17 is a flowchart for explaining an example of processing for confirming, for example, an inventory state of commodities in a commodity shelf with the shelf analyzing apparatus 3.

The processor 31 of the shelf analyzing apparatus 3 receives, for each of photographed images, an input of an image processing result from the image processing apparatus 2 through the I/F 34 (ACT 91). The processor 31 extracts an object related to a commodity stock of a shelf among objects included in the photographed image (ACT 92). For example, the processor 31 extracts a shelf label as the object related to the commodity stock of the shelf among the objects included in the photographed image. In this case, the processor 31 extracts an image region of the object of the shelf label from the photographed image and extracts description information of the shelf label from the image region. The description information of the shelf label is information concerning a commodity management code, a commodity name, a price, a best before date, a shelf display period, and the like. The processor 31 extracts the description information of the shelf label according to image recognition and OCR processing for an image of the object in the photographed image. The description information of the shelf label may be information obtained by the image recognition or the OCR processing in the image processing apparatus 2.

If the extraction of the object concerning the commodity stock of the shelf included in one photographed image ends (YES in ACT 93), the processor 31 returns to ACT 91 and executes the same processing on the next photographed image. If the processing ends concerning all the photographed images (YES in ACT 94), the processor 31 executes final decision processing for objects concerning commodity stocks of shelves in the entire store (ACT 95). As the final decision processing, the processor 31 checks whether a plurality of objects are present for a component in the same commodity shelf and specifies objects concerning commodity stocks in the commodity shelves in the entire store.

If the final decision processing ends, the processor 31 estimates display quantities of commodities in the commodity shelves from the objects concerning the commodity stocks of the shelves included in the photographed images (ACT 96). For example, the processor 31 estimates the numbers of commodities present in the commodity shelves using a recognition result of the commodities serving as the objects concerning the commodity stocks of the shelves. The processor 31 may estimate display quantities of the commodities using not only the object information of the commodities included in the photographed images but also, for example, stock quantities of the commodities specified by description information of shelf labels. For example, the processor 31 can acquire, referring to the commodity master 33d, maximum stock quantities and theoretical stock quantities of the commodities specified from the description information of the shelf labels. In this case, the processor 31 is capable of estimating the numbers of commodities present in the commodity shelves included in the photographed images using the maximum stock quantities or the theoretical stock quantities.

If the display quantities of the commodities are estimated, the processor 31 determines stockouts and shortages of the commodities from the estimated display quantities of the commodities (ACT 97). For example, if a commodity indicated by description information of a shelf label cannot be detected from a photographed image, the processor 31 determines that the commodity is in stockout. If an estimated display quantity of a commodity is smaller than a predetermined quantity for determining a shortage, the processor 31 determines that the commodity is in shortage. The processor 31 may determine a shortage using a determination algorithm for determining a shortage based on a display state of commodities in a commodity shelf.

If a determination result of the stockouts and the shortages is obtained, the processor 31 outputs the determination result of the stockouts and the shortages concerning the commodities in the commodity shelves (ACT 98). For example, the processor 31 may display, on the display 36, commodities determined as the stockouts and commodities determined as the shortages. The processor 31 may display, on the display 36, information indicating the commodity shelves in which the commodities determined as the stockouts and the commodities determined as the shortages are disposed.

According to the processing explained above, the shelf analyzing apparatus determines stockouts and shortages of the commodities based on an image processing result for a plurality of photographed images of the commodity shelves in the store photographed by the moving photographing apparatus while moving in the store. The shelf analyzing apparatus displays, on the display, a determination result of the stockouts and the shortages of the commodities in the store. Consequently, the shelf analyzing apparatus can determine the stockouts and the shortages of the commodities in the store from the plurality of photographed images photographed by the moving photographing apparatus while moving in the store and can inform the stockouts, the shortages, and the like to the operator.

### Second Embodiment

A second embodiment is explained below.

In the second embodiment, a shelf management system that acquires information concerning a commodity shelf present in a region photographed while moving a photographing position in a short time using a small device is assumed. The shelf management system according to the second embodiment realizes the various kinds of processing explained in the first embodiment using a portable terminal such as a smartphone with a camera as the small device.

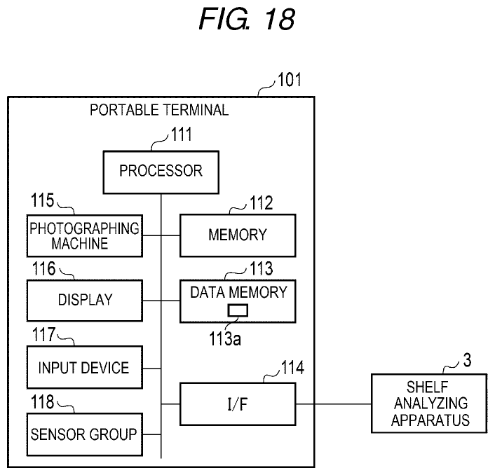

FIG. 18 is a block diagram illustrating a configuration example of the shelf management system according to the second embodiment.

In the configuration example illustrated in FIG. 18, the shelf management system is configured by a portable terminal 101 and the shelf analyzing apparatus 3. The portable terminal 101 is a device that realizes the functions of the moving photographing apparatus 1 and the image processing apparatus 2 explained in the first embodiment. The portable terminal 101 is, for example, a smartphone with a camera function or a tablet PC with a camera. The portable terminal 101 only has to be a device having a function of executing various kinds of processing and held by an operator in a hand to move a photographing position.

The shelf analyzing apparatus 3 according to the second embodiment may be equivalent to the shelf analyzing apparatus 3 illustrated in FIGS. 1 and 2 explained in the first embodiment. The shelf analyzing apparatus 3 may be realized by a cloud server disposed on a network and communicable with the portable terminal 101. Further, in the shelf management system according to the second embodiment, the portable terminal 101 may realize the processing function by the shelf analyzing apparatus 3 explained in the first embodiment. For example, the processing illustrated in FIGS. 15 to 17 explained in the first embodiment may be realized by an application program installed in the portable terminal 101.

In the configuration example illustrated in FIG. 18, the portable terminal 101 includes a processor 111, a memory 112, a data memory 113, an interface (I/F) 114, a photographing machine (a camera) 115, a display 116, an input device 117, and a sensor group 118.

The processor 111 manages control of the entire portable terminal 101. The processor 111 realizes various kinds of processing by executing programs. The processor 111 is, for example, a CPU. The processor 111 executes programs stored by the memory 112 or the data memory 113 to thereby realize operation control, data processing, and the like of the units. The memory 112 is configured by various memory devices. For example, the memory 112 includes memory devices such as a RAM, a ROM, and an NVM.

The data memory 113 stores various data. The data memory 113 is configured by a rewritable storage device such as a HDD (hard disk drive) or an SSD (solid state drive). The data memory 113 stores an image photographed by the camera 115, photographing position information, photographing condition information, and the like. The data memory 113 includes a storage region 113a that retains a reference image for processing a certain photographed image (e.g., an image photographed immediately before the certain photographed image) if data processing is executed.

The interface 114 is an interface for communicating with the shelf analyzing apparatus 3. The interface 114 transfers, for example, a result of image processing to the shelf analyzing apparatus 3. The interface 114 may be an interface that performs information transmission by wire or may be an interface that performs information communication by wireless transmission. The interface 114 receives an input of information via an information input terminal such as a USB, a LAN port, or a wireless antenna.

The camera 115 photographs an image. The camera 115 includes an image sensor configured by a photoelectric conversion element and a lens that guides a video in a photographing range to the image sensor. The image sensor of the camera 115 has known sizes (Sx and Sy). The camera 115 photographs an image at a predetermined focal length (f).

The display 116 is a display device that displays information. The input device 117 is a device for the operator to input information. The input device 117 is configured by a touch panel, a keyboard, or the like. For example, the display 116 and the input device 117 may be configured as a display device with a touch panel. In the following explanation in the second embodiment, it is assumed that the portable terminal 101 includes a display device with a touch panel functioning as the display 116 and the input device 117.

The sensor group 118 includes various sensors that detect information for specifying a position where an image is photographed. The portable terminal 101 includes an acceleration sensor, a gyro sensor, a magnetic sensor, and an atmospheric pressure sensor as sensors for obtaining photographing position information. The sensor group 118 only has to include a sensor that can measure a direction and a movement of the portable terminal 101 (or the camera 115). A sensor that measures a position in a plan view of a store may be provided in the sensor group 118. However, actually, it is not easy to provide, in the portable terminal 101, the sensor that measures a position on a plane of the store. The portable terminal 101 can calculate a homography component indicating a geometrical positional relation between a photographed image and the next photographed image if the sensors of the sensor group 118 measure a direction and a movement from a photographing start position.

Operation for photographing a commodity shelf using the portable terminal 101 is explained.

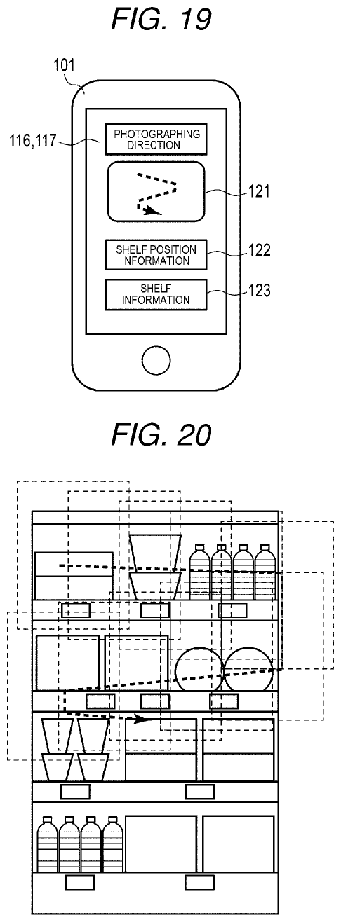

FIG. 19 is a diagram illustrating an example of an exterior configuration of the portable terminal 101. FIG. 20 is a diagram illustrating a state in which the commodity shelf is photographed using the portable terminal 101.

As illustrated in FIG. 19, the portable terminal 101 includes a display with a touch panel. The portable terminal 101 executes photographing of the commodity shelf according to operation by the operator. Before starting the photographing, the portable terminal 101 displays a screen for inputting photographing related information on the display 116. The operator inputs the photographing related information with the input device 117 according to a guide displayed on the display 116.

In the example illustrated in FIG. 19, the display 116 of the portable terminal 101 displays a display field 121 indicating a photographing direction (a photographing route) for the commodity shelf. The display 116 also displays, for example, an icon 122 for instructing an input of shelf position information and an icon 123 for instructing input of shelf information such as a reference number. For example, the portable terminal 101 determines, according to the input shelf position information and shelf information and the like, a photographing direction for photographing the commodity shelf with the camera 115 and displays the photographing direction in the display field 121.

After the photographing related information is input, the operator moves the portable terminal 101 (the camera 115) according to the photographing direction displayed on the display 116. In the photographing route illustrated in FIG. 20, the operator photographs the entire commodity shelf by moving a photographing region 40 of the camera 115 from the upper left of the commodity shelf toward the lower right while swiping the photographing region 40 in the lateral direction. The portable terminal 101 displays the photographing route illustrated in FIG. 20 on the display 116 to thereby support the operation for photographing the entire commodity shelf without omission in the photographing region.

If the operator moves the portable terminal 101 along the photographing route illustrated in FIG. 20, the camera 115 photographs a plurality of images in a photographing range illustrated in FIG. 20. For example, the portable terminal 101 displays, on the display 116, in real time, an image obtained by stitching a plurality of photographed images photographed by the camera 115. Consequently, the operator can visually confirm, with the image displayed on the display 116, whether the photographing range (the movement of the portable terminal 101) is proper. The portable terminal 101 may display information such as photographing completion on the display 116 and inform the photographing completion.

The portable terminal 101 performs the same image processing as the image processing apparatus 2 explained in the first embodiment while photographing an image. For example, every time the portable terminal 101 acquires a photographed image photographed by the camera 115, the portable terminal 101 executes image processing using, as a reference image, a photographed image photographed immediately before the photographed image. If the photographing ends, the portable terminal 101 outputs a result of the image processing for the photographed image to the shelf analyzing apparatus 3. Consequently, the shelf analyzing apparatus 3 can execute, based on the result of the image processing output from the portable terminal 101, the processing illustrated in FIGS. 15 to 17 and the like.

The operation of the portable terminal 101 according to the second embodiment is explained.

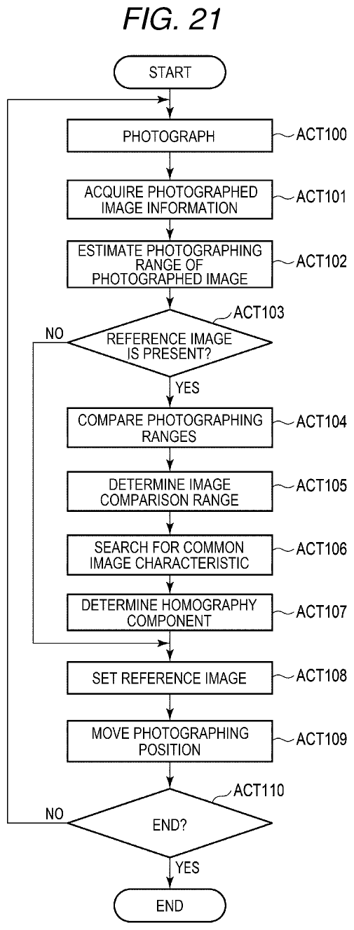

FIG. 21 is a flowchart for explaining an operation example of the portable terminal 101 in the shelf management system according to the second embodiment.

FIG. 21 illustrates processing conforming to the image photographing processing by the moving photographing apparatus 1 illustrated in FIG. 9 and the image processing by the image processing apparatus 2 illustrated in FIG. 10 explained in the first embodiment. That is, the portable terminal 101 according to the second embodiment continuously executes the photographing processing by the moving photographing apparatus 1 and the image processing by the image processing apparatus 2 explained in the first embodiment.

First, the processor 111 of the portable terminal 101 executes a program for executing the photographing processing and the image processing by the shelf management system. For example, as illustrated in FIG. 19, the processor 111 of the portable terminal 101 displays, on the display 116, operation guidance or the like for photographing a commodity shelf. Consequently, the operator operates the portable terminal 101 according to the guidance displayed on the display 116.

The processor 111 of the portable terminal 101 performs photographing of an image by the camera 115 according to operation by the operator (ACT 100). The processor 111 performs the photographing of an image by the camera 115 while detecting a moving state (a moving direction, a movement amount, etc.) of the portable terminal 101 with the sensors of the sensor group 118. For example, the processor 111 operates the camera 115 according to movement of the portable terminal 101 detected by the sensor group 118 and photographs an image. The processor 111 may perform the image photographing by the camera 115 at a predetermined period while the operator is moving the portable terminal 101.

If the camera 115 photographs the image, the processor 111 acquires photographed image information including a photographed image, photographing position information indicating a photographing position, and photographing condition information (ACT 101). For example, the processor 111 manages the photographed image, the photographing position information, and the photographing condition information as photographed image information associated with a photographed image ID. For example, the processor 111 acquires the photographed image, the photographing position information, and the photographing condition information according to processing equivalent to ACTS 14, 16, and 18 in FIG. 9. However, the processor 111 of the portable terminal 101 may acquire, as the photographing position information, information indicating a moving position from a photographing start position.

If the photographed image information is acquired, the processor 111 estimates a photographing range of the acquired photographed image (ACT 102). For example, as in ACT 32 or ACT 35 in FIG. 10, the processor 111 calculates a photographing range of the photographed image based on, for example, the relation explained with reference to FIGS. 5 and 7. For example, the processor 111 of the portable terminal 101 estimates a photographing distance and the like based on information detected by the sensors of the sensor group 118.

If the photographed image information and the photographing range are obtained, the processor 111 confirms whether a reference image is already set (ACT 103). If the reference image is not set, that is, if the photographed image is a photographed image photographed first (NO in ACT 103), the processor 111 sets the acquired photographed image as the reference image (ACT 108).

If the reference image is already set (YES in ACT 103), the processor 111 performs processing for comparing the photographing range of the photographed image and a photographing range of the reference image (ACT 104). For example, the processor 111 calculates a geometrical overlapping region of the photographing range of the reference image and the photographing range of the photographed image according to a difference between the photographing position of the reference image and the photographing position of the photographed image.

If the overlapping region of the reference image and the photographed image is calculated, the processor 111 determines a range in which an image feature value included in the reference image and an image feature value included in the photographed image are compared (an image comparison range) (ACT 105). In order to efficiently compare the reference image and the photographed image, the processor 111 limits the range in which the image feature values included in both the images are compared.

If the image comparison range is determined, the processor 111 performs matching processing of the reference image and the photographed image in the image comparison range (ACT 106). As the matching processing, the processor 111 extracts a local feature value included in the reference image and a local feature value included in the photographed image. If the local feature values are extracted from the reference image and the photographed image, the processor 111 matches the local feature value of the reference image and the local feature value of the photographed image to search for a common image characteristic.

The processor 111 determines a homography component between the reference image and the photographed image based on a result of the matching processing of the reference image and the photographed image (ACT 107). For example, the processor 111 can calculate, based on the matching of the reference image and the photographed image, a geometrical overlapping range of the photographed image on the reference image according to homography matrix calculation. The processor 111 may calculate a photographing range of the photographed image from the reference image information according to the matching of the reference image and the photographed image.

If the photographing range and the homography component of the photographed image are determined, the processor 111 sets the photographed image as the reference image (ACT 108). The processor 111 sets, as reference image information, the photographing position information and the photographing condition information of the photographed image and sets (updates) the photographing range of the photographed image as the photographing range of the reference image.

If the photographed image is set as the reference image, the processor 111 moves the photographing position of the camera 115 according to operation of the portable terminal 101 by the operator (ACT 109). If the photographing of the image by the camera 115 does not end (NO in ACT 110), the processor 111 returns to ACT 100 and executes photographing of the next image.

According to the processing explained above, the portable terminal 101 acquires photographing ranges of a plurality of photographed images by the camera 115 and a homography component for the reference image. The portable terminal 101 can execute the processing illustrated in FIGS. 11 and 12 explained in the first embodiment using the information acquired by the processing explained above. Consequently, in the second embodiment, it is possible to carry out the same image photographing and the same image processing as the first embodiment using the portable terminal, which is the small device that can be carried by the operator.

As explained above, according to the first and second embodiments, the shelf management system photographs the entire shelf in a plurality of photographing positions while moving. The shelf management system calculates movement amounts from photographing positions of other photographed images based on photographing positions of the photographed images. The shelf management system compares, in a range set according to a movement amount between two photographed images, image information of both the images (e.g., compares image feature values of the images). The shelf management system specifies an overlapping region of the photographing ranges according to the movement amount and the comparison of the image information. The shelf management system specifies states of objects in the entire shelf considering the determined overlapping region of the photographing ranges.

Consequently, the shelf management system can more robustly, accurately, and efficiently specify a correlation between the two photographed images than when overlapping of the two photographed images is determined by only a correlation of the image feature values, that is, the comparison of the image information. As a result, the shelf management system can highly accurately and efficiently specify objects present in the shelves in the store from a plurality of photographed images photographed while moving in the store and can highly accurately perform an analysis of the shelves.

In photographing commodity shelves set in the store while moving in the store, it is assumed that photographed images include a large number of objects having less characteristics such as plain cardboard boxes and walls. In a commodity shelf in which the same commodities are often disposed side by side, in some case, image feature values compared between photographed images are less or similar image feature values are repeatedly generated in the photographed images. Even in such a case, the shelf management systems according to the first and second embodiments can highly accurately and efficiently determine overlapping between the photographed images taking into account a movement amount between the photographed images. As a result, the shelf management systems according to the first and second embodiments can highly accurately carry out determination of objects present in the commodity shelves from a plurality of photographed images photographed while moving in the store.

The several embodiments are explained above. However, the embodiments are presented as examples and are not intended to limit the scope of the invention. These new embodiments can be implemented in other various forms. Various omissions, substitutions, and changes can be made without departing from the spirit of the invention. These embodiments and modifications of the embodiments are included in the scope and the gist of the invention and included in the inventions described in claims and the scope of equivalents of the inventions.

What is claimed is:

1. A shelf management system comprising:
an interface configured to receive an input of photographed image information including a plurality of photographed images photographed by changing a photographing position with respect to a shelf in which objects including commodities are disposed and photographing position information indicating photographing positions of the photographed images;
a memory configured to retain one photographed image among the plurality of photographed images as a reference image; and
a processor configured to execute matching processing of the reference image and other photographed images based on the photographing positions and image feature values and output information concerning the objects present on the shelf determined according to a result of the matching processing.

2. The system according to claim 1, wherein the photographed image information includes photographing condition information indicating a photographing condition for specifying a photographing range of the photographed image.

3. The system according to claim 1, wherein the processor executes matching of the image feature values in an image comparison range based on the photographing position of the reference image and position information of the other photographed images.

4. The system according to claim 1, wherein the objects include the commodities disposed on the shelf and labels posted on the shelf.

5. The system according to claim 1, further comprising a second processor configured to collate information concerning the objects present on the shelf specified by the processor from the plurality of photographed images with information registered in a database.

6. The system according to claim 1, wherein the interface is configured to receive an input of photographed image information wirelessly.

7. The system according to claim 1, further comprising an autonomous apparatus comprising a camera to provide the input of photographed image information to the interface.

8. A shelf management method comprising:
receiving an input of photographed image information including a plurality of photographed images photographed by changing a photographing position with respect to a shelf in which objects including commodities are disposed and photographing position information indicating photographing positions of the photographed images;
recording one photographed image among the plurality of photographed images in a memory as a reference image; and
executing matching processing of the reference image and other photographed images based on the photographing positions and image feature values and outputting information concerning the objects present on the shelf determined according to a result of the matching processing.

9. The method according to claim 8, wherein the photographed image information includes photographing condition information indicating a photographing condition for specifying a photographing range of the photographed image.

10. The method according to claim 8, further comprising matching of the image feature values in an image comparison range based on the photographing position of the reference image and position information of the other photographed images.

11. The method according to claim 8, further comprising collating information concerning the objects present on the shelf specified from the plurality of photographed images with information registered in a database.

12. The method according to claim 8, further comprising receiving an input of photographed image information wirelessly.

13. The method according to claim 8, providing the input of photographed image information to the interface wirelessly.

14. The method according to claim 8, further comprising:
determining stockouts and shortages of the commodities from an estimated display quantities of the commodities based on a display state of commodities on a commodity shelf.

15. A shelf analyzing apparatus comprising:
an image capture device configured to obtain photographed image information;
an interface configured to receive an input of photographed image information including a plurality of photographed images photographed by changing a photographing position with respect to a shelf in which objects including commodities are disposed and photographing position information indicating photographing positions of the photographed images;
a memory configured to retain one photographed image among the plurality of photographed images as a reference image; and
a processor configured to execute matching processing of the reference image and other photographed images based on the photographing positions and image feature values and output information concerning the objects present on the shelf determined according to a result of the matching processing.

16. The apparatus according to claim 15, wherein the photographed image information includes photographing condition information indicating a photographing condition for specifying a photographing range of the photographed image.

17. The apparatus according to claim 15, wherein the processor executes matching of the image feature values in an image comparison range based on the photographing position of the reference image and position information of the other photographed images.

18. The apparatus according to claim 15, wherein the objects include the commodities disposed on the shelf, shelf stages, and labels posted on the shelf.

19. The apparatus according to claim 15, further comprising an autonomous apparatus comprising the image capture device to provide the input of photographed image information to the interface.

20. The apparatus according to claim 15, wherein the processor is further configured to determines stockouts and shortages of the commodities from an estimated display quantities of the commodities.
